(19) United States
(12) Patent Application Publication
(10) Pub. No.: US 2004/0205936 A1
(43) Pub. Date: Oct. 21, 2004

(54) Escutcheon plate assembly

(76) Inventor: Andre Denys, Sterling Heights, MI (US)

Correspondence Address: Thomas N. Young, Suite 624, 3001 West Big Beaver Road, Troy, MI, 48084, US

(21) Appl. No.: 10/414,065

(22) Filed: Apr. 15, 2003

(51) Int. Cl. B62B 1/00

(52) U.S. Cl. 16/412

(57) ABSTRACT

An escutcheon plate assembly including a pair of opposing escutcheon plates operably connected to an inside portion and an outside portion respectively of a door. The escutcheon plates each have an inner surface, an outer surface and elongate pocket formed by a raised edge protruding around the perimeter of the plates. A stiffening insert is positioned in the pocket adjacent the inner surface of each plate. The stiffening insert is operably associated with the escutcheon plates for providing lightweight structural support. A thumb-turn having an adjustable telescoping tail located adjacent the inside plate is provided for connecting to a locking mechanism in a door. The adjustable tail can be extended and contracted for use with various types of doors having varying thicknesses.

### FIELD OF THE INVENTION

This invention relates to escutcheon plate assemblies and more particularly to escutcheon plate assemblies for use with sliding doors.

### BACKGROUND OF THE INVENTION

Escutcheon plate assemblies are commonly used on sliding doors in both commercial and residential buildings. There are a variety of different sizes and shapes of escutcheon plates on the market today covering various hole patterns such as 3, 4, or 6 holes. The industry standard for fastener hole spacing for attaching escutcheon plates to a door is 3 15/16 inches.

It is difficult to manufacture thin wall lightweight escutcheon plates at low costs while maintaining durability and quality standards. Escutcheon plates can be made of metal or plastic, but in either case, they will tend to bend or break if they are designed to minimize the wall thickness.

### SUMMARY OF THE INVENTION

In general, the present invention provides an escutcheon plate assembly of light weight, thin wall design which can be used as original equipment as well as for replacement, and which overcomes problems associated with prior art thin wall assemblies.

An escutcheon plate assembly includes a pair of escutcheon plates operably connected to an inside portion and an outside portion respectively of a door. The escutcheon plates have an outer surface and an inner surface forming a thin wall therebetween. An elongate pocket adjacent the inner surface is formed by a raised edge protruding around the perimeter of the escutcheon plates. A stiffening insert is positioned in the pocket adjacent the inner surface of each escutcheon plate. The stiffening inserts are operably associated with the escutcheon plates for providing lightweight structural support for preventing the thin walled escutcheon plates from deforming under stress caused by a pulling load transmitted from an associated handle.

In an illustrative embodiment of the invention, a slot is formed on each side of the inside escutcheon plate for providing access for a thumb-turn. The thumb-turn is positionable on either the left-hand or right-hand side of the escutcheon plate. A slot cover is positionable between the stiffening insert and the inside escutcheon plate for covering the unused slot opposite of the thumb-turn. An adjustable telescoping tail is provided with the thumb-turn. The telescoping tail of the thumb-turn has a set screw for locking the tail at a length that corresponds with the thickness of the door.

Further in the illustrative embodiment, the inside escutcheon plate has a thumb-turn cradle installed therein for aligning the thumb-turn in a desired orientation prior to assembling the inside stiffening insert in the pocket of the escutcheon plate. After the cover for the thumb-turn slot is placed opposite of the thumb-turn, either on the left or the right side, a handle is attached to the escutcheon plate. On the outside portion of the door, the outer escutcheon plate is also supported with a stiffening insert. A gasket operably associated with the outer escutcheon plate is provided for sealing the outer escutcheon plate assembly to the door. The gasket prevents ingress of foreign materials such as moisture and/or dirt. After the handles are attached to both the outer and inner escutcheon plates, the escutcheon plate assemblies can be attached to the door by inserting threaded fasteners through apertures located on the inside escutcheon plate and threading the fasteners into threaded posts fixedly located in the outer stiffening insert adjacent the outer escutcheon plate. The escutcheon plate assemblies can be used to retrofit existing doors that have been installed in homes and businesses as well as on new doors in current production.

Other applications of the present invention will become apparent to those skilled in the art when the following description of the best mode contemplated for practicing the invention is read in conjunction with the accompanying drawings.

### BRIEF DESCRIPTION OF THE DRAWINGS

The description herein makes reference to the accompanying drawings wherein like reference numerals refer to like parts throughout the several views, and wherein:

FIG. 1 is an exploded view of an escutcheon plate assembly;

FIG. 2a is a front perspective view of an outside escutcheon plate with a lock cylinder;

FIG. 2b is a side perspective view of the outside escutcheon plate with a lock cylinder;

FIG. 2c is a back perspective view of the outside escutcheon plate with a lock cylinder;

FIG. 3a is a side view of a stiffening insert for the outside escutcheon plate with threaded posts;

FIG. 3b is a front view of a stiffening insert for the outside escutcheon plate;

FIG. 4a is a front perspective view of an inside escutcheon plate;

FIG. 4b is a back perspective view of the inside escutcheon plate;

FIG. 4c is a side perspective view of the inside escutcheon plate;

FIG. 5a is a side cross-sectional view of a stiffening insert for the inside escutcheon plate;

FIG. 5b is a front perspective view of a stiffening insert for the inside escutcheon plate;

FIG. 6a is a side view of the outside escutcheon plate and stiffening insert with insert posts having anti-rotation features;

FIG. 6b is a perspective view of the outside escutcheon plate and stiffening insert with insert posts having external threads;

FIG. 6c is a perspective view of the D-shaped head of the post;

FIG. 7 is a perspective view of a thumb-turn cradle;

FIG. 8a is a perspective view of a thumb-turn with an adjustable tail;

FIG. 8b is a perspective view of a T-shaped cross section of the adjustable tail;

FIG. 9a is a perspective view of the inside escutcheon plate with a thumb-turn assembled on the left-hand side;

FIG. 9b is a perspective view the inside escutcheon plate with the thumb-turn assembled on the right-hand side;

FIG. 10a-10d are perspective views of the various handles and attaching positions that can be accommodated by the present invention;

FIG. 11 is a perspective view of an outer handle with inserts;

FIG. 12A is an exploded view of an alternate thumb-turn assembly; and

FIG. 12B is a perspective view of the thumb-turn assembly of 12A assembled with the inner escutcheon plate assembly.

### DESCRIPTION OF THE PREFERRED EMBODIMENT

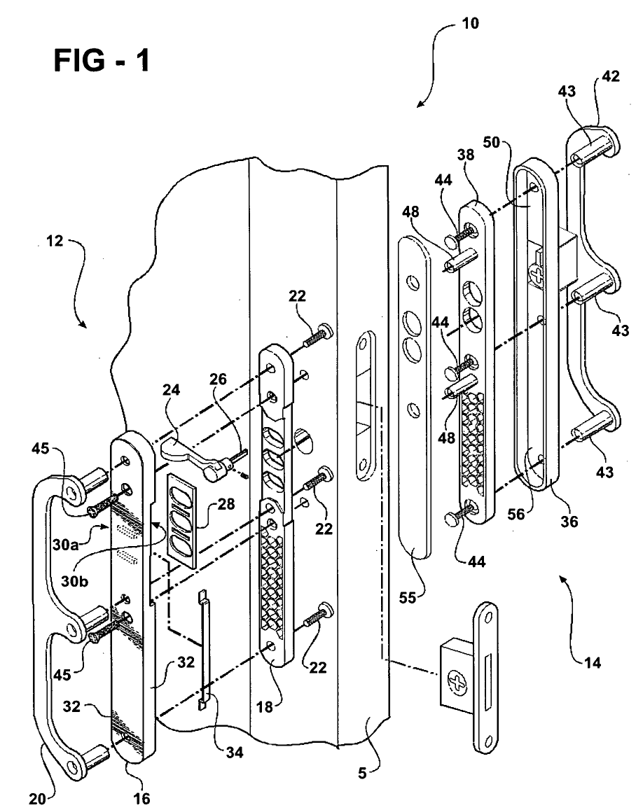

Referring to FIG. 1, an escutcheon plate assembly 10 is shown therein. The escutcheon plate assembly 10 is generally broken into an inner escutcheon plate assembly 12 and an outer escutcheon plate assembly 14. An inner escutcheon plate 16 is assembled with an inner stiffening insert 18 on one side of the inner escutcheon plate 16 and an inside handle 20 positioned on the other side of the inner escutcheon plate 16. Threaded fasteners 22 extend through the inner stiffening insert 18 and the inner escutcheon plate 16 into threaded engagement with the inside handle 20. A thumb-turn 24 having an adjustable tail 26 is positioned between the inside stiffening insert 18 and a thumb-turn cradle 28. The inner escutcheon plate 16 includes a pair of slots 30a, 30b formed in each elongated side 32 of the inner escutcheon plate assembly 16. A slot cover 34 covers either slot 30a or 30b on the side opposite of the thumb-turn 24 location.

The outer escutcheon plate assembly 14 includes an outer escutcheon plate 36 with a stiffening insert 38 positioned in an elongated pocket 56 adjacent the inner surface 50 of the outer escutcheon plate 36. An outer handle 42 is connected to the outer escutcheon plate on the opposite side of the outer stiffening insert 38. Threaded fasteners 44 extend through the outer stiffening insert 38 and the outer escutcheon plate 36 into threaded engagement with the outer handle 42. The inner escutcheon plate assembly 12 and outer escutcheon plate assembly 14 are assemble to the door with threaded fasteners 45 that extend through the inner escutcheon plate 16, the inner stiffening insert 18, a door 5 and into threaded posts 48 operably positioned in the outer stiffening insert 38. A gasket 55 is positioned between the outer escutcheon plate 36 and the door 5 for preventing ingress of foreign contaminants such as dirt and/or moisture. A detailed description of each of these components will follow.

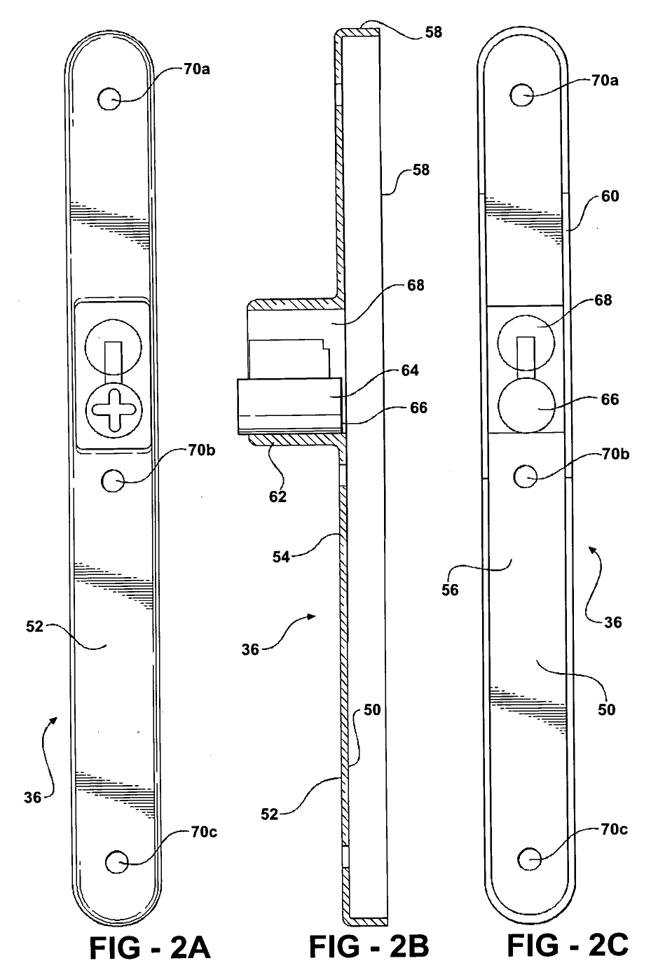

Referring now to FIGS. 2a, 2b, and 2c, the outer escutcheon plate 36 is shown herein. The outer escutcheon plate 36 has an inner surface 50 and an outer surface 52 forming a thin wall 54. A thin wall with respect to escutcheon plate designs is typically defined as less than 0.060 inches. Thin walled escutcheon plates will bend or break under typical loading without additional mechanical support. An elongated pocket 56 is formed by a raised edge 58 protruding inwardly from the outer surface 52 around the perimeter 60 of the outer escutcheon plate 36. The outer escutcheon plate 36 includes an integral lock housing 62 for holding a lock mechanism 64 that can be actuated by a key (not shown) for locking the door to a stationary member (also not shown). The lock mechanism 64, also called a key cylinder, can be placed in one of two positions. The lock mechanism 64, shown best in FIG. 2b, is positioned in a lower position 66, however, the lock mechanism 64 can be flipped 180° and positioned in a second position 68, which is the upper position, to give flexibility with respect to the various handle designs that can be used with the outer escutcheon plate assembly 14.

The outer escutcheon plate 36 includes a plurality of through apertures 70a, 70b, and 70c, for permitting threaded fasteners 44 (shown in FIG. 1) to extend therethrough and attach the outer handle 42 (shown in FIG. 1) to the outer escutcheon plate 36. The outer handle 42 can be attached at one or more of these locations depending on the particular design that is desired. The outer handles 42 have tapped bores or threaded inserts 43 (shown in FIG. 1) for engaging with the threaded fasteners 44 and attaching the outer escutcheon plate assembly 14 to the door 5. The lock housing 62 is positioned off center on the outer escutcheon plate 36 for providing hand clearance for grasping the outer handle 42 on the door. The lock mechanism 64, or locking cylinder, can be actuated with a key or a keypad for unlocking the door 5 from the outside. The outer escutcheon plate 36 can be installed in a first position as shown in FIG. 2b or can be flipped 180° out of phase, with the first position such that the lock mechanism 64 can alternatively be located in the lower half of the outer escutcheon plate 36 relative to the outer handle 42.

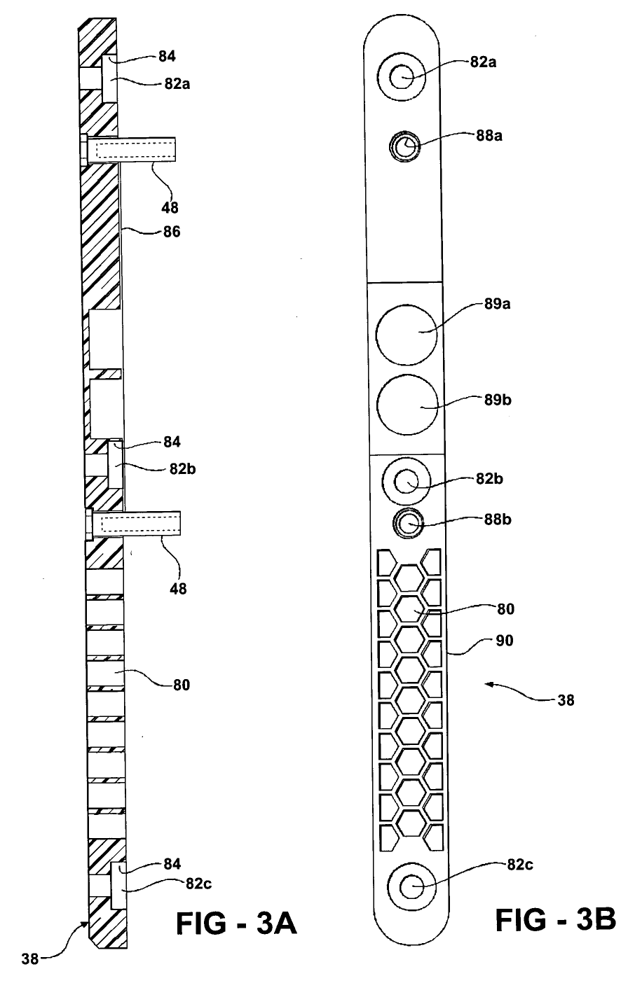

Referring now to FIGS. 3a and 3b, the outer stiffening insert 38 is shown therein. The outer stiffening insert 38 is made of a lightweight material, preferably plastic, for strengthening and supporting the outer escutcheon plate 36. Some examples of suitable plastic materials include, but are not limited to, polypropylene, polyethylene, ABS, nylon, and polycarbonate. The outer stiffening insert 38 is positioned in the elongated pocket 56 of the outer escutcheon plate 36. The outer stiffening insert 38 is operably associated with the outer escutcheon plate 36 for providing a lightweight structural support to the thin wall 54 of the outer escutcheon plate 36 such that the outer escutcheon plate 36 will not plastically deform or fracture when a pulling load from the outer handle 42 is transmitted into the outer escutcheon plate 36. The outer stiffening insert 38 can be partially formed of a plastic honeycombed structure 80. The outer stiffening insert 38 also includes through apertures 82a, 82b, 82c corresponding with apertures 70a, 70b, 70c in the outer escutcheon plate 36. Each aperture 82a, 82b, 82c includes a counter-bore 84 for positioning the head of the threaded fasteners 44 (shown in FIG. 1) therein such that the head may remain flush with an inner surface 86 of the outer stiffening insert 38. The outer stiffening insert 38 has a second pair of through apertures 88a and 88b that threaded posts fixedly engage with for connecting the outer escutcheon plate assembly 14 to the inner escutcheon plate assembly 12. Apertures 88a and 88b in the outer stiffening insert 38 provide a path for internally threaded posts 48 to pass through and receive threaded fasteners 45 extending from the inner escutcheon plate assembly 12. The threaded fasteners 45 threadingly engage the posts 48 and attach the inner escutcheon plate assembly 12 and the outer escutcheon plate assembly 14 to the door 5.

Apertures 89a and 89b provide optional paths for the adjustable tail 26 of the thumb-turn 24 to pass through and engage with the lock mechanism 64. Apertures 89a, 89b correspond with the upper 68 and lower 66 positions that the lock mechanism 64 can optionally be assembled in. The honeycomb structure 80 is formed in an extension 90 defined by the distance between aperture 88b which holds the outer escutcheon plate assembly 14 to the door and aperture 82c which attaches to the outer handle 42. The distance between apertures 88b and 82c can be relatively long which causes a large moment to form about aperture 88b as a result of the pulling force on the outer handle 42. The outer escutcheon plate 36 will tend to bend around the fastened position located at aperture 88b without additional support. The outer stiffening insert 38 provides that additional support and will prevent plastic deformation of the outer escutcheon plate 36 under typical pulling loads.

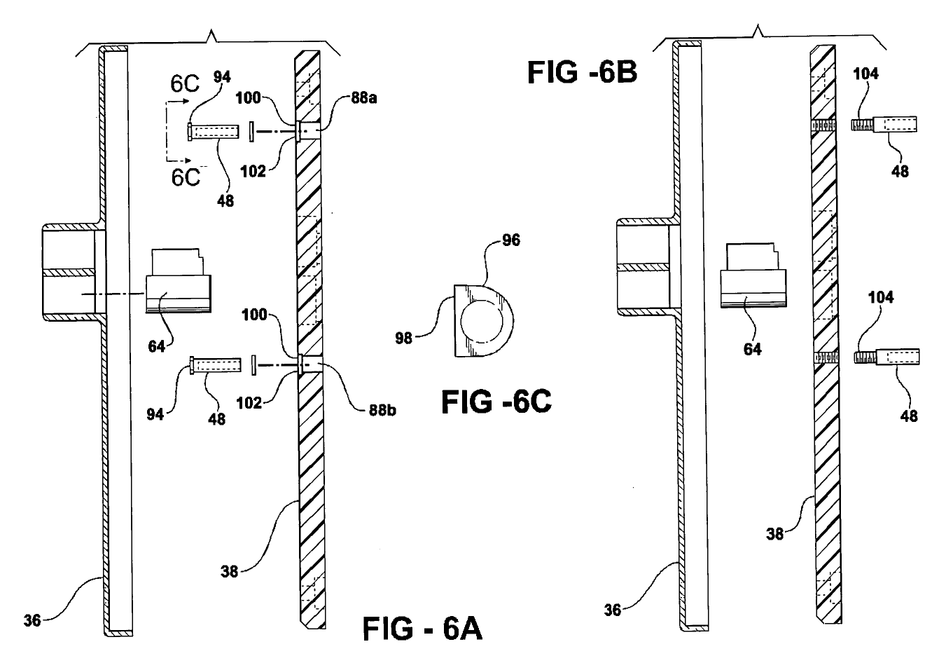

Referring now to FIGS. 6a, 6b, and 6c, the outer stiffening insert 38 and the internally threaded posts 48 are shown in an exploded view. The threaded posts 48 are operable for providing engagement with threaded fasteners 45 (shown in FIG. 1) extending from the inner escutcheon plate assembly 12, through the door 5 and into the internally threaded posts 48. The posts 48 can have an anti-rotation feature 94 formed thereon for preventing the post 48 from rotating relative to the outer stiffening insert 38. The anti-rotation feature 94 can be a substantially D-shaped head 96 as shown in FIG. 6c. A flat surface 98 of the D-shaped head 96 rests adjacent a corresponding flat surface 100 located in a counter-bore 102 of the through apertures 88a, 88b. The D-shaped head 96 is operable for preventing rotational movement of the post 48 with respect to the stiffening insert 38 when the threaded fastener 45 is torqued into the post 48. The threaded post 48, alternatively, can include external threads 104 as shown in FIG. 6b. The external threads 104 of the threaded post 48 will either further tighten or bottom out as the threaded fasteners 45 are torqued into the threaded post 48.

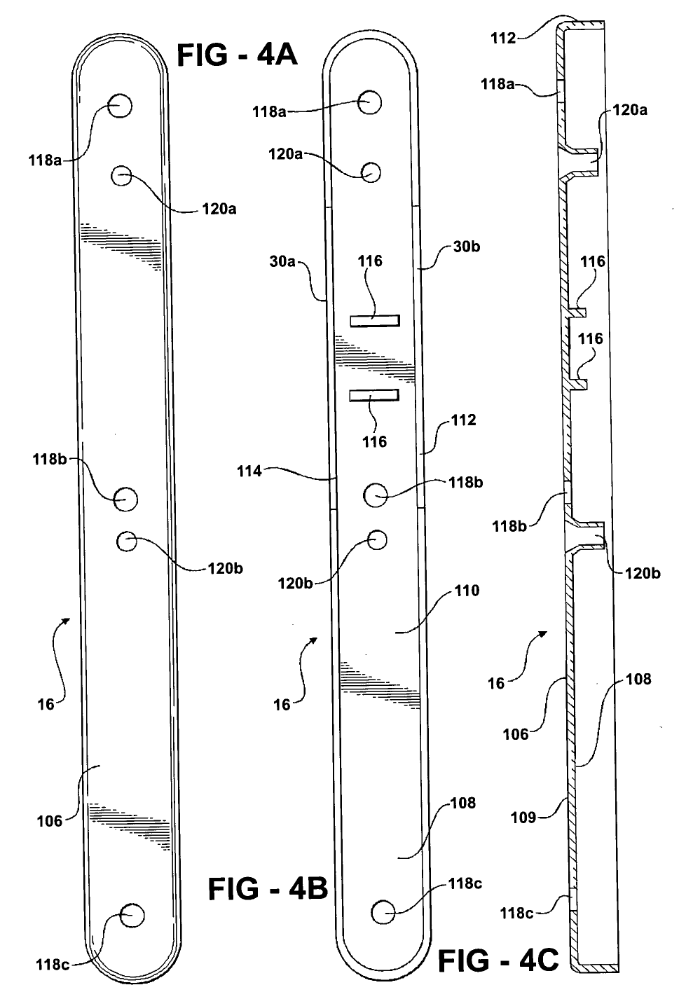

Referring now to FIGS. 4a, 4b, and 4c, the inner escutcheon plate 16 is shown therein. The inner escutcheon plate 16 has an outer surface 106 to which the inner handle 20 (shown in FIG. 1) is attached and an inner surface 108 which faces the door 5. An elongated pocket 110 is formed by a raised edge 112 protruding inwardly from the outer surface 106 around the perimeter 114 of the inner escutcheon plate 16. The inner surface 108 of the inner escutcheon plate 16 includes raised tabs 116 for engaging the thumb-turn cradle 28. A thin wall 109 is formed between the outer surface 106 and the inner surface 108. A plurality of apertures 118a, 118b, and 118c are included on the inner escutcheon plate 16 for attaching the inner handle 20 thereto. The inner escutcheon plate 16 includes two through apertures 120a and 120b for permitting threaded fasteners 45 (shown in FIG. 1) to pass through and connect the inside escutcheon plate assembly 12 with the outer escutcheon plate assembly 14 when the threaded fasteners 45 are threadingly engaged with the threaded post 48 positioned in the outer stiffening insert 38. A pair of slots 30a, 30b (best seen in FIG. 1) are formed in the raised edge 112 of each side of the inner escutcheon plate 16. The pair of slots allow the thumb-turn 24 to be positioned on either side of the inner escutcheon plate 16 as shown in FIGS. 9a and 9b. The slot cover 34 (shown in FIG. 1) is positioned on the opposite side of the thumb-turn for covering the slot 30a or 30b that is not being used by the thumb-turn 24.

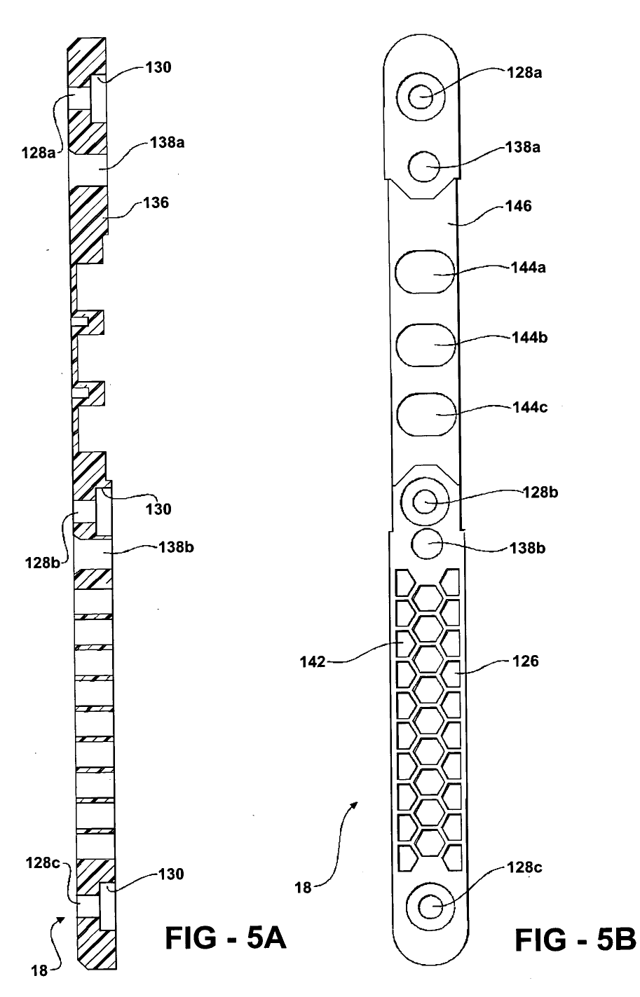

Referring now to FIGS. 5a and 5b, a cross-sectional view and a front view of the inner stiffening insert 18 is shown therein. The inner stiffening insert 18 is made of a lightweight material, preferably plastic for strengthening and supporting the inner escutcheon plate 16. The inner stiffening insert 18 is positioned in the elongated pocket 110 of the inner escutcheon plate 16. The inner stiffening insert 18 is operably associated with the inner escutcheon plate 16 for providing a lightweight structural support to the thin wall 109 of the inner escutcheon plate 16 such that the inner escutcheon plate 16 will not plastically deform or fracture when a pulling load from the inner handle 20 is transmitted into the inner escutcheon plate 16. The inner stiffening insert 18 can be formed at least partially of a plastic honeycomb structure 126.

The inner stiffening insert 18 includes a plurality of through apertures 128a, 128b, 128c corresponding with apertures 118a, 118b, 118c located in the inner escutcheon plate 16. Each aperture 128a, 128b, 128c includes a counterbore 130 for positioning the head of the threaded fasteners 22 (shown in FIG. 1) flush with an outer surface 136 of the inner stiffening insert 18. The inner stiffening insert 18 has a second pair of through apertures 138a and 138b that correspond to the threaded posts 48 positioned in the outer stiffening insert 38. A pair of threaded fasteners 45 pass through apertures 120a, 120b of the inner escutcheon plate 16 and through apertures 138a and 138b of the inner stiffening insert 18 before threadingly engaging the posts 48.

The honeycomb structure 126 of the stiffening insert 18 is formed in an extension 142 defined by the distance between aperture 138b which holds the assembly to the door and aperture 128c which attaches to the inner handled 20. The distance between aperture 138b and 128c is relatively long which causes a large moment to form about aperture 138b as a result of the pulling force on the inner handle 20. The inner escutcheon plate 16 will tend to bend around the fastened position located at aperture 138b without additional support. The inner stiffening insert 18 provides that additional support and will prevent plastic deformation of the inner escutcheon plate 16 under typical loading conditions. A plurality of ovalized apertures 144a, 144b, 144c are positioned longitudinally along the elongated length of the stiffening insert 18. The ovalized apertures 144a, 144b, 144c, are provided for locating and holding the thumb-turn 24 in a desired position relative to the inside escutcheon plate 16. The outer surface 146 has a cutaway portion 148 for providing space between the inner stiffening insert 18 and the inner escutcheon plate 16 for the thumb-turn 24 and thumb-turn cradle 28 to set in.

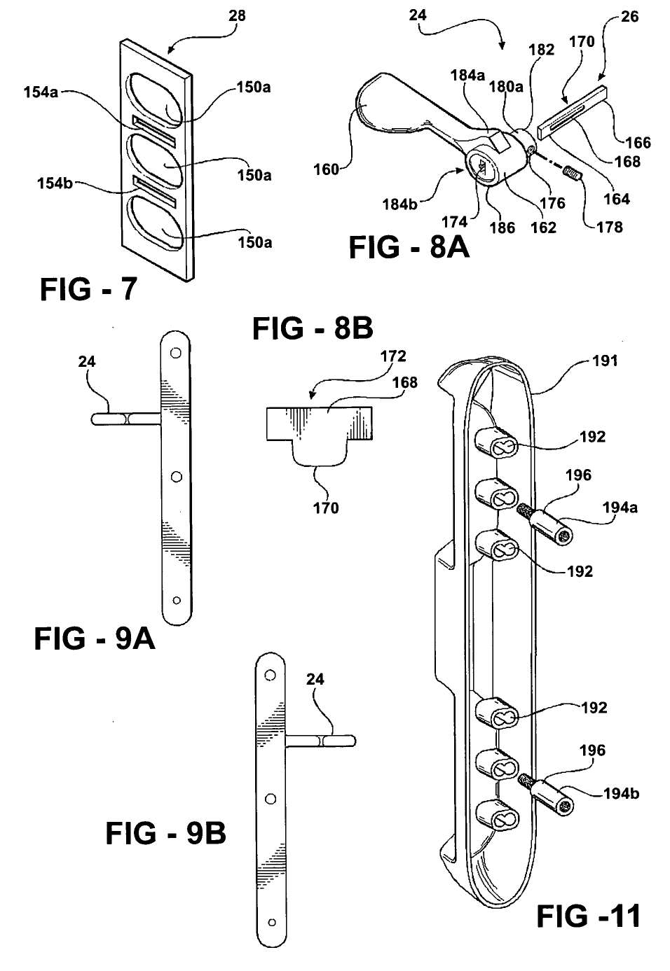

Referring now to FIG. 7, the thumb-turn cradle 28 is shown therein. The thumb-turn cradle 28 has a plurality of ovalized apertures 150a, 150b, 150c corresponding to the plurality of ovalized apertures 144a, 144b, 144c of the inner stiffening insert 18. The thumb-turn cradle 28 includes a pair of slots 154a, 154b for engaging the raised tabs 116 formed on the inner surface 108 of the inner escutcheon plate 16. The thumb-turn cradle is fixedly locked into the correct location when the slots 154a, 154b slidingly engage the tabs 116 of the inner escutcheon plate 16.

Referring now to FIG. 8a and 8b, a thumb-turn 24 having an adjustable telescoping tail 26 is shown therein. The thumb-turn 24 has a lever 160 integrally extending from a housing 162 for actuating the lock mechanism 64. The adjustable tail 26 has a first end 164 and a second end 166. The adjustable tail includes a groove 168 extending adjacent the first end toward an intermediate portion of the tail 26. The groove 168 in the tail 26 can be formed by stamping, forging, or other similar manufacturing processes. A protruding rib 170 is formed on the tail 26 opposite of the internal groove 168. The tail 26 with the protruding rib 170 forms a substantially T-shaped cross-section 172 as shown in FIG. 8a. The first end 164 of the tail 26 having the T-shaped cross-section 172 is inserted into the thumb-turn housing 162. The thumb-turn housing 162 has a substantially T-shaped slot 174 formed therein for providing a guide surface for the T-shaped cross section 172 of the adjustable tail 26 to slidingly engage with. The thumb-turn housing 162 has a threaded aperture 176 in which a set screw 178 can be threaded therewith for extending into the groove 168 of the tail 26 and locking the tail 26 with respect to the housing 162. The set screw 178, even when loosened, prevents the adjustable tail 26 from completely disengaging from the housing 162 unless the set screw 178 is backed all the way out of the housing 162.

The adjustable tail 26 can be adjustably positioned relative to the housing 162 along the entire length of the groove 168. The adjustable tail 26 is locked with the set screw 178 at a desired length to correspond with a thickness of a door being used for a particular application. The length of the telescoping tail 26 can be adjusted between doors having thicknesses from 1″ to 1.75″ inclusive in one embodiment. A second embodiment includes an adjustable telescoping tail 26 operable on doors having thicknesses from 1.75″ and 2.25″, inclusive. Other thicknesses of doors are also contemplated by this invention and this disclosure should not be limited to the standard adjustable tails 26 described herein. Using telescoping adjustable tails 26 with the thumb-turns 24 reduces the number of individual thumb-turns 24 required to be stocked because the adjustable tail 26 covers a majority of standard door thicknesses used in the industry.

The thumb-turn 24 is positioned between the thumb-turn cradle 28 and the inner stiffening insert 18. A round-bearing surface 180a is formed on one end 182 of the housing 162 for engaging with one of the ovalized slots 144a, 144b, 144c of the inner stiffening insert 18. Protruding winged surfaces 184a, 184b are formed on the second end 186 of the thumb-turn housing 162. The winged surfaces 184a, 184b prevent the thumb-turn 24 from passing through the ovalized apertures 144a, 144b, 144c of the inner stiffening insert 18 or the ovalized apertures 150a, 150b, 150c of the thumb-turn cradle 28.

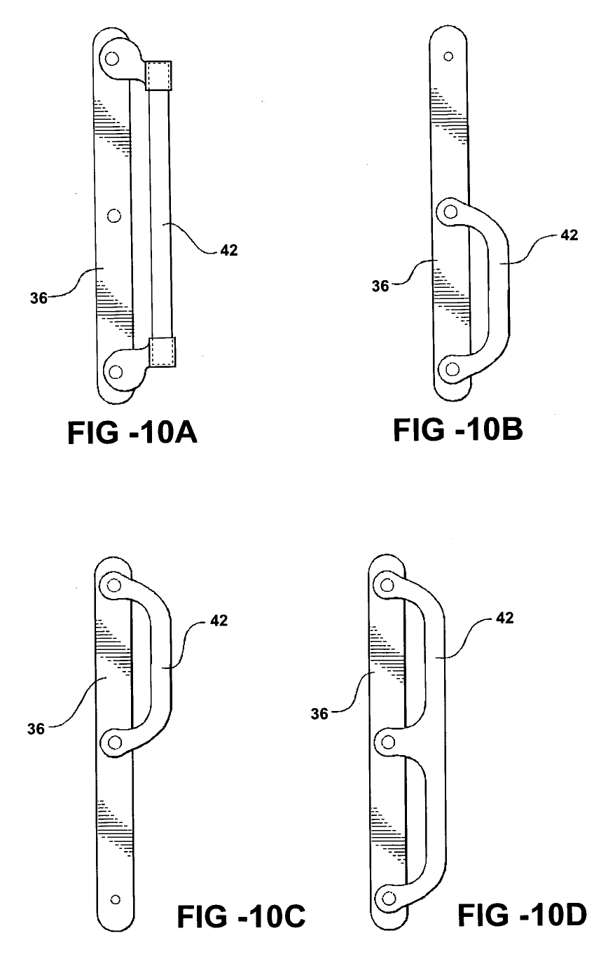

Referring now to FIGS. 10a through 10b, various door handles and attaching methods are shown therein. The handle 42 can extend from one end of the escutcheon plate 36 to the other end as shown in FIG. 10a and connect at two locations. A handle can connect between the intermediate aperture and the lower end, as shown in FIG. 10b. The handle can connect between an intermediate position and an upper aperture position as shown in FIG. 10c. Finally, the handle can connect at three positions and extend along substantially the entire length of the escutcheon plate as shown in FIG. 10d. There are no limits to the handle design or attachment locations, because the escutcheon plates 16, 36 are manufactured without through holes and are subsequently “drilled” to match any desired handle design.

Referring now to FIG. 11, a view of a prior art attachment handle 191 is shown therein. The typical outer handle has a plurality of double-tapped bosses 193 for connecting to a door 5. In order to connect the inner escutcheon plate assembly 12 described in this invention, threaded posts 194a and 194b can be used to adapt the escutcheon plate hardware to the prior art outer door handle. Utilizing the standardized threaded posts 194a and 194b will reduce the number and types of threaded fasteners required for retrofitting the inner escutcheon plate assembly 12 with an old handle 191. Typically, the double-tapped bosses 193 are not the right size and/or the threaded fasteners will bottom out in the double-tapped bosses 193. An additional benefit with using the standardized posts 194a, 194b is that the body 196 of the post 194 helps prevent the escutcheon plate assembly 10 from moving relative to the door 5 as typically occurs with smaller diameter fasteners. The larger body diameter 196 reduces the potential movement between the escutcheon plate assembly 10 and the door.

Referring now to 12A and 12b, an alternate embodiment of the thumb-turn is shown therein. The thumb-turn 200 has a first lever portion 202 extending from the inner surface 108 of the inner escutcheon plate 16. A second lever portion 204 extends adjacent the outer surface 106 of the inner escutcheon plate 16. The first lever portion 202 and the second lever portion 204 are operably connected to one another with a threaded fastener 206 that extends through an end portion 208 of the second lever portion 204 and into an end portion 210 extending from the first lever portion 202. The end portion 208 of the second lever portion 204 includes a through aperture 212 for inserting the threaded fastener 206 therethrough for threadingly engaging a threaded aperture 214 positioned in the end 210 of the first lever portion 202. The inner surface 216 of the second lever portion 204 includes a threaded aperture 218 for receiving a threaded member 220 having a nylon tip 221. The nylon tip 221 of the threaded member 220 engages the outer surface 106 of the inner escutcheon plate 16. The nylon-tipped fastener 220 prevents wearing of the outer surface 106 of the inner escutcheon plate 16 when the thumb-turn 200 is actuated to alternately lock and unlock the door.

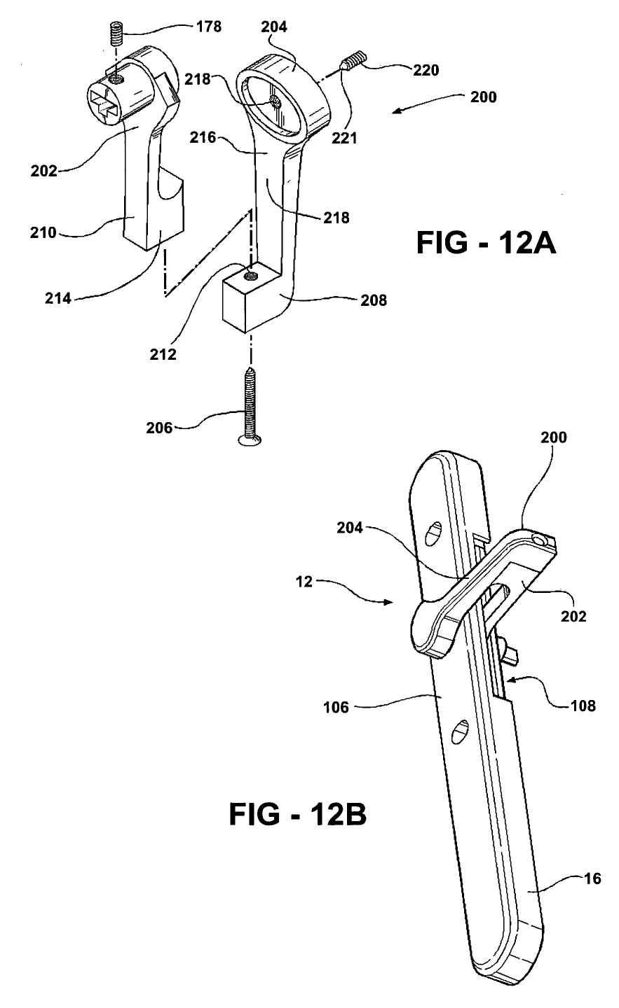

The thumb-turn 200 is operably assembled with the inner escutcheon plate assembly 12 such that the thumb-turn 200 is actuated by depressing either the first lever portion 202 or the second lever portion 204 as shown in FIG. 12B. The assembled thumb-turn 200 will actuate the locking mechanism (not shown) such that the door can alternately be locked or unlocked using either the inner portion 202 or the outer lever portion 204, or both.

While the invention has been described in connection with what is presently considered to be the most practical and preferred embodiment, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

1. An escutcheon plate assembly comprising:
first and second pair opposing escutcheon plates operably connected to an inside portion and an outside portion, respectively, of a door, each escutcheon plate having an inner surface facing the door, an outer surface facing a handle, and an elongate pocket adjacent the inner surface formed by a raised edge protruding inwardly from the outer surface around the perimeter of the plates; and
first and second stiffening inserts positioned in the pocket adjacent the inner surface of the first and second plates, respectively, for providing lightweight structural support thereto.

2. The escutcheon plate assembly of claim 1, wherein each stiffening insert is formed of plastic material.

3. The escutcheon plate assembly of claim 1, wherein each stiffening insert is at least partially formed of a honeycomb structure.

4. The escutcheon plate assembly of claim 1 further comprising:
a slot formed in the raised edge of each elongate side of the inner escutcheon plate for permitting a thumb-turn to be positioned on one of either the left hand side and right hand side of the inner escutcheon plate.

5. The escutcheon plate assembly of claim 4 further comprising:
a slot cover positionable between the stiffening insert and the inner escutcheon plate for covering the unused slot on the elongate side of the inner escutcheon plate opposite of the thumb-turn.

6. The escutcheon plate assembly of claim 1 further comprising:
a lock housing integrally formed on the outer surface of the outer escutcheon plate, the lock housing positioned off center with respect to the outer escutcheon plate for providing hand clearance when grasping a handle on the door, the plate rotatable 180 degrees such that the lock housing can alternatively be located at one of either an upper half and a lower half of the outer escutcheon plate.

7. The escutcheon plate assembly of claim 1 further comprising:
a thumb-turn having an adjustable telescoping tail and a set screw threadingly engagable with the thumb-turn for locking the adjustable tail at a desired length to correspond with a thickness of the door.

8. The escutcheon plate assembly of claim 7, wherein the length of the tail is operable in doors having thicknesses of between 1 inch and 1.75 inches inclusive.

9. The escutcheon plate assembly of claim 7, wherein the length of the tail is operable in doors having thicknesses of between 1.75 inches and 2.5 inches inclusive.

10. The escutcheon plate assembly of claim 1 further comprising:
a gasket operably positioned between the outer escutcheon plate and the door for preventing ingress of contaminants into the escutcheon plate assembly.

11. The escutcheon plate assembly of claim 1 further comprising:
at least one internally threaded post positioned in the outer stiffening insert, the threaded post having an anti rotation feature formed thereon for preventing rotation of the at least one post relative to the stiffening insert.

12. The escutcheon plate assembly of claim 11, wherein the anti-rotation feature of the post is a substantially D-shaped head, the flat surface of the head contacting an adjacent flat surface of the stiffening insert thereby preventing rotational movement of the post with respect to the stiffening insert.

13. The escutcheon plate assembly of claim 11, wherein the at least one internally threaded post includes external threads for threadably engaging a tapped insert located in the stiffening insert.

14. The escutcheon plate assembly of claim 11 further comprising:
a first pair of apertures extending through the inner escutcheon plate and the at least one stiffening insert for permitting a threaded fastener to extend between the inner escutcheon plate and outer escutcheon plate, the fasteners threadably engaging the threaded posts for connecting the escutcheon plates to the door.

15. The escutcheon plate assembly of claim 1 further comprising:
a plurality of apertures positioned in each plate and each corresponding stiffening insert for connecting at least one handle to each plate.

16. The escutcheon plate assembly of claim 1 further comprising:
a handle operably connected to the at least one escutcheon plate, the handle substantially spanning the entire elongate length of the escutcheon plate.

17. The escutcheon plate assembly of claim 16, wherein the handle is positioned substantially along one of either a lower half of the escutcheon plate and an upper half of the escutcheon plate.

18. The escutcheon plate assembly of claim 1 further comprising:
a thumb-turn cradle for holding a thumb-turn in a desired position relative to the inside escutcheon plate, the cradle having a plurality of longitudinally spaced ovalized apertures for positioning the thumb-turn vertically in a specified aperture and laterally with respect to the side of the escutcheon plate that the thumb-turn is located.

19. An escutcheon plate assembly comprising:
a pair of opposing escutcheon plates operably connected to an inside portion and an outside portion respectively of a door, the escutcheon plates having an inner surface, an outer surface, and an elongate pocket formed by a raised edge protruding inwardly around the perimeter of the plates;
a slot on each side of the inside plate for permitting a thumb-turn to be positioned on one of either the left hand and right hand sides of the plate; and
a slot cover positionable between the inner escutcheon plate and the door covering the unused slot opposite the thumb-turn.

20. An escutcheon plate assembly for use with a sliding door assembly including a door and a latch mechanism including an actuator controlling the latch mechanism. the escutcheon plate assembly comprising:
a pair of opposing escutcheon plates operably connected to an inside portion and an outside portion respectively of a the door, the plates having an inner surface, an outer surface, and an elongate pocket formed by a raised edge protruding inwardly around the perimeter of the plates;
a slot in the raised edge of the inner escutcheon plate on one side of the inner escutcheon plate; and
a thumb-turn having a central hub portion positioned in the pocket of the inner escutcheon plate and a lever portion projecting radially outwardly from the hub portion and through the slot for access by a user, the thumb-turn further including a tail extending axially from the hub portion for engagement with the latch mechanism actuator the tail being adjustable axially to allow effective actuator engagement irrespective of varying door thicknesses.

21. The escutcheon plate assembly of claim 20, wherein the adjustable tail further comprises:
an elongated groove formed longitudinally along an upper surface thereof, and a set screw operably engaging the groove for locking the adjustable tail with respect to the thumb-turn.

22. The escutcheon plate assembly of claim 21 wherein the adjustable tail further comprises:
a protruding rib formed longitudinally along a lower surface opposite of the groove, the rib of the adjustable tail forming a substantially T-shaped cross section for engaging a similarly shaped T-shaped groove in a thumb-turn housing.

23. An escutcheon plate assembly
including an escutcheon plate and a thumb turn the escutcheon plate operably connected to an inside portion of a door and having an inner surface an outer surface, and an elongate pocket formed by a raised edge protruding inwardly around the perimeter of the plate with a slot in the edge at one side of the escutcheon plate providing access to the pocket;
the thumb turn having a hub portion positioned in the pocket of the escutcheon plate a first lever portion extending outwardly from the hub portion adjacent the inner surface of the escutcheon plate and through the slot; and a second lever connected to a free end of the first lever portion and doubling back on the first lever portion to a free end portion [extending] adjacent the outer surface of the inner escutcheon plate.

24. (Cancelled).

25. (Cancelled).

26. The escutcheon plate assembly of claim 27, wherein the non-abrasive tip of the threaded member is made of nylon material.

27. An escutcheon plate assembly comprising:
a pair of opposing escutcheon plates operably connected to an inside portion and an outside portion respectively of a door, the plates having an inner surface, an outer surface, and an elongate pocket formed by a raised edge protruding around the perimeter of the plates, the plates designed to attach to the door in one of two positions oriented 180° apart from one another; and
a thumb turn positioned adjacent the inner escutcheon plate, the thumb turn having an adjustable telescoping tail locked into position with a set screw;
the thumb turn further comprising a first lever portion extending adjacent the inner surface of the inner escutcheon plate and a second lever portion extending adjacent the outer surface of the inner escutcheon plate;
the second lever portion including a threaded member having a substantially non-abrasive tip for engaging with and preventing wear to the outer surface of the inner escutcheon plate when the thumb-turn is actuated.

28. An escutcheon plate assembly comprising an outer escutcheon plate assembly for positioning against an outer surface of a door, an inner escutcheon plate assembly for positioning against an inner surface of the door, and attaching means for securing the inner and outer escutcheon plates to the door; characterized in that the attachment means comprises:
a threaded socket on one of the escutcheon plate assemblies;
a threaded fastener engaging the other escutcheon plate assembly; and
a post having an internally threaded socket at one end threadably receiving the threaded fastener and an externally threaded section at another end received in the threaded socket on the one escutcheon plate assembly.

29. An escutcheon plate assembly according to claim 28 wherein:
the inner escutcheon plate assembly includes an escutcheon plate having an inner surface, an outer surface, and an elongate pocket formed by a raised edge protruding inwardly around the perimeter of the plate with a slot in the edge at one side of the plate providing access to the pocket;
the escutcheon plate assembly further includes a thumb turn having a central hub portion positioned in the pocket and a lever portion extending radially outwardly from the hub portion and through the slot for access by a user;
the thumb turn further includes a tail extending axially from the hub portion for engagement with a door actuator; and
the tail is adjustable axially to allow effective actuator engagement irrespective of varying door thicknesses.
